(19) United States
(12) Patent Application Publication
(10) Pub. No.: US 2002/0115053 A1
(43) Pub. Date: Aug. 22, 2002

(54) Method, apparatus and article of manufacture for identifying, evaluating and particularizing automated response system performance

(76) Inventors: Paul M. Thibado, Fayetteville, AR (US); Vincent P. LaBela, Fayetteville, AR (US); Daniel W. Bullock, Fayetteville, AR (US)

Correspondence Address: Trent C. Keisling, HEAD, JOHNSON & KACHIGIAN, E.J. Ball Plaza, Suite 230, 112 West Center Street, Fayetteville, AR, 72701, US

(21) Appl. No.: 09/792,088

(22) Filed: Feb. 22, 2001

(51) Int. Cl. G09B 3/00; G09B 7/00

(52) U.S. Cl. 434/353

(57) ABSTRACT

A computer based method, apparatus and article of manufacture for identifying and grading a responding individual's performance when indicators of said performance are included within a personal response system generated file structure. The invention as practiced in its preferred embodiment enhances the art and addresses limitations of contemporary automated response systems by presenting a response stimulus to a plurality of individuals, eliciting a recordable response to said stimulus from such individuals, digitally recording the elicited response from each individual comprising said plurality of individuals, attributing a recorded response to each individual comprising said plurality and grading each individual's attributed response performance.

### REFERENCE TO PENDING APPLICATIONS

This application is not related to any pending applications.

### REFERENCE TO MICROFICHE APPENDIX

This application is not referenced in any microfiche appendix.

### TECHNICAL FIELD OF THE INVENTION

The invention relates generally to a personal response system data processing method, apparatus and article of manufacture. In particular, the present invention relates to a computer based method, apparatus and article of manufacture for identifying and grading an individual's response performance when such performance has been recorded and interspersed within a personal response system generated file structure containing a plurality of performance records generated from a plurality of responding individuals.

### BACKGROUND OF THE INVENTION

The role self-motivation plays in learning cannot be overstated. However, students particularly students enrolled in general education courses, students who do not perceive the learning material as valuable or students grouped together in large classes render most difficult, if not impossible, an instructor's ability to devote sufficient time and energies to a particular student to insure his or her comprehension of class subject matter, self motivation or class participation.

In the past, strides have been made in learner-centered teaching methods which enhance the student-instructor engagement process. One such present art method is referred to as “Personal Response System”. As used herein, the term Personal Response System, or PRS, refers generically to prior art private response or selection systems, as opposed to any one specific proprietary PRS. An example of one contemporary system would be the aptly named Personal Response System® owned by Varitronixs Ltd. and distributed by EduCue throughout the United States. These systems are well known to those in the art and provide for an individual's private response or selection utilizing a free forming one-way network of wireless communication. Utilizing a PRS, an audience member, responds privately to a response stimulus such as a question or prompt. Group member responses are then garnered and summarized with collated results displayed as a histogram for the audience, and a PRS facilitator, to perceive. Similarly, in the classroom environment, PRS is typically practiced by every student first renting a handheld remote control unit that has embedded into it a unique transmission code. When the student arrives at class, a response stimulus is presented to the student audience. Each member of the audience then responds privately to the posed question via their handheld remote control, all responses are collected, and the summarized results displayed as a histogram for all to observe.

The benefits of the present invention can best be appreciated having once had the opportunity to overview the capabilities and limitations of existing art personal response systems. Prior art illustration 1 illustrates an example of a typical personal response system.

In Prior Art FIG. 1 it is observed where PRS system questions or selections are cast in a multiple-choice format and members of an audience respond by pressing down on a single-digit button of a pocket-size wireless transmitter 1.01. The transmitted response signals are then intercepted by a portable receiver 1.02 which in turn is connected to a display device 1.03 via an electronic circuit or a PC 1.04. Each time a signal from a transmitter 1.01 is received, a histogram 1.05 shown on the display 1.03 is altered to include the value represented by the transmitted signal. The answer itself is not displayed. At the end of a question period, a statistical summary of all answers (a.k.a values) received from all transmitted responses can be shown on the display 1.03 as a histogram either automatically, or via key stroke or mouse/GUI interface. In short, a PRS is a tool for electioneering, voting, or response indication which provides an audience, such as a student class with group response results.

In a comprehensive article published in the American Journal of Physics [Vol. 66(1998) pp. 64-74], Richard R. Hake showed unequivocally that the use of Interactive Engagement (IE) strategies in the classroom increases mechanics-course effectiveness well beyond that obtained with traditional methods. The study was based on a survey of pre/post test data of about 6000 students in high schools, colleges, and universities using the Halloun-Hastenes Mechanics Diagnostic test (MD) or Force Concept Inventory (FCI). Defining the average of normalized gain <g> as the ratio of the actual average gain (<post %>-<pre %>) to the maximum possible average gain (100-<per %>), Hake found <g>T-ave=0.23±0.04 and <g>IE-ave=0.48+0.14. The effectiveness of IE approaches is about twice that of traditional approaches, according to these measures.

IE methods are those designed at least in part to promote conceptual understanding through interactive engagement of students to heads-on (always) and hands-on (usually) activities which yield immediate feedback through discussion with peers and/or instructors. For practitioners of traditional lecture method who wish to try the IE approach, immediate feedback and reinforcement (IFR) using electronic devices appears an easy and most practical IE approach to adopt. Consequently, a PRS provides an easy to use, low cost, and very flexible electronic tools for undertaking an IFR approach in the classroom.

### BRIEF SUMMARY OF THE INVENTION

The present invention represents a labor saving enhancement for instructors in terms of identifying and evaluating an individual's response performance and provides for a secure, interactive anonymous learning environment wherein individuals are motivated to participate actively in classroom or other similarly intended audience forums. In so doing, it provides a class instructor with the ability to quiz and monitor grades on a routine, variable or real-time basis and students with incentive to (1) attend class and participate and (2) study class materials throughout the semester and not just before a major test. Consequently, the instant invention provides an effective teaching tool that assists instructors by automatically tying and grading in-class student participation, and encourages students in attendance to remain engaged versus struggling through large lecture classes.

Improving upon the existing art which limits itself to the displaying of composite answers on a large projected screen in the front of the classroom, the present invention further provides for the identification and grading of individuals and an interactive environment wherein students answer questions during each class with their in-class responses comprising a certain percent of their final grades. The instant invention further provides in its practice the capability where even wrong answers can receive some credit to encourage attendance. By monitoring the progress, or lack thereof, of an individual student's participation, an instructor can easily see and understand the student's grasp of concepts as the course progresses allowing the instructor to initiate immediate remedial measures to re-emphasize subject areas requiring additional attention.

The invention provides for both real-time and batch processing modes of execution. In the real-time mode, the software processes of the invention may be executed in-class and results indicative of a year-to-date or indeed, a “year-to-response” or variable time period grade for a specific student or group of students presented to the instructor for evaluation.

In the batch processing mode the software of the invention may be executed and reports or displays of a student's or group of students, year-to-date or variable time period grades may be provided at scheduled (fixed) or variably timed intervals.

Succinctly stated, the present invention contemplates and expands upon the capabilities of contemporary prior art personal response systems. In the present art, personal response systems are limited to, and merely allow for, a plurality of individuals to indicate a selection in response to the presentation of response stimulus, with individual responses accumulated and displayed as a composite representation of the group's selection of multiple answer responses. Therein lies the novelty, uniqueness and import of the present invention. In that, the instant invention, further identifies a student provided response to a specific individual's transmitter and compares that response to one or more possible answer scenarios, with the individual's performance parsed out of the group accumulation and made available for distinguishable evaluation. Consequently, the present invention allows for such identification/parsing and grading via a unique presentation of data processing concepts.

A major object of the instant invention is to enhance the existing art by extending the capabilities of today's personal response system and providing instantaneous year-to-date, and in a “real-time” mode, even a year to last response grading of an individual student's in-class participation.

Another significant object of the invention is to allow for the automated grading of numerous quiz responses in either a real-time or batch processing mode.

It is a further object of the instant invention to foster enhanced student attention to an instructor's in class presentation(s) and queries.

An additional object of the instant invention is to provide for and influence 100% participation in question-and-answer sessions.

Yet another object of the instant invention is to provide instant feedback for each individual student's response.

A further object of the instant invention is to provide a degree of assurance to the instructor that ensures a lesson has been reasonably understood before proceeding.

Another object of the instant invention is to promote proactive student participation in class.

An additional object of the invention is to encourage students to study the material throughout the semester and not just before a major test.

Yet another object of the invention is to provide for an effective teaching tool that assists students to remain engaged versus struggling through large lecture classes.

Other objects and further scope of the applicability of the present invention will become apparent from the detailed description to follow, taken in conjunction with the accompanying drawings wherein like parts are designated by like reference numerals.

### DESCRIPTION OF THE DRAWINGS

FIG. 1 presents a personal response system typical of the prior art further illustrating functional components and component interrelationships.

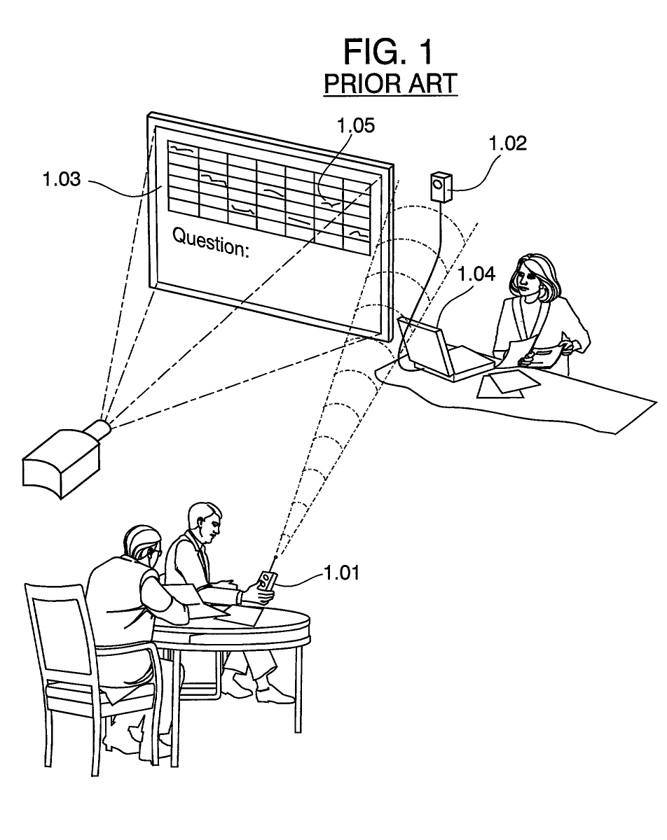

FIG. 2 illustrates a logic flow diagram of the instant invention as practiced in its preferred embodiment.

FIG. 3 illustrates major hardware and software components of the instant invention when practiced in its batch, variable or fixed interval execution environment.

FIG. 4 illustrates major hardware and software components of the instant invention when practiced in its preferred real-time execution environment.

### DETAILED DESCRIPTION OF THE PREFERRED EMBODIMENT

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that changes may be made in the details of construction, sequence of methodology step execution and the arrangement of invention hardware and software components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

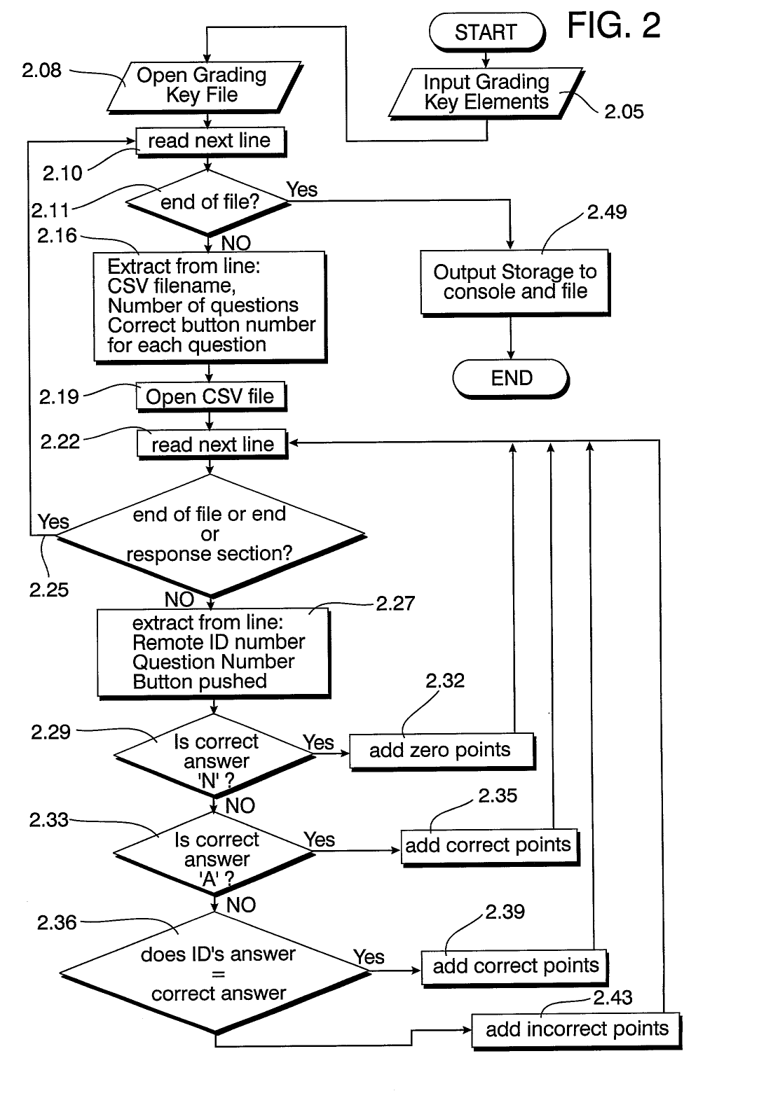

FIG. 2 illustrates the logic flow sequence of the instant invention when practiced in its preferred embodiment. It is again emphasized and clear to those skilled in the art that the methodology's instruction step sequences may be altered and still effectuate the design and purpose of the instant invention. Turning now to FIG. 2.

In FIG. 2 a PRS facilitator (herein synonymously referred to as “instructor”) first inputs the output filename utilized by present art PRS software and the correct button number for each question posed as grading key file records via a keyboard or mouse/GUI 2.05. For purposes of disclosure clarity said output filename will be referenced to hereinafter synonymously as “CSV” or “CSV filename” and refers to a file within which a present art PRS's logs or stores transmitted responses. When inputting, the correct button number for a particular question may be replaced by ‘n’ in which case no remote identification number (ID) will receive points for the question or, the correct button number may be replaced by ‘a’ in which case all remote ids will receive the correct points for the question.

The invention next opens the grading key file 2.08 and reads in each line 2.10 (a.k.a. “record”) and exits when the end of the file has been read 2.11. For each record read from the grading key file, the CSV filename and the correct button numbers are extracted 2.16. The CSV file is then opened 2.19 and each record of the CSV file is read 2.22 until the end of file, or end of the question response section is determined. Whenever an end of file condition or the end of a question response section is determined, the software of the instant invention branches to read the next available grading key file record 2.25. When the record read of the CSV file is determined to be neither an end of file indicator or the end of the question response section, the question number, the remote ID number and the button number pressed is extracted 2.27. Next, the computer based method of the present invention undertakes the assignment of points for each remote ID identified in the CSV file is performed, with the total number of points for each remote ID encountered in the CSV file maintained in storage, having first initialized said total for each remote ID to zero points. The correct response for the question number read from the CSV file is next examined. If the correct response is ‘n’ 2.29 then a number of points representing zero points is added to the remote ID's total 2.32. If the correct response is ‘a’ 2.33 then a number of points representing the points awarded if correct is added to the remote ID's total 2.35. Should the correct response be neither ‘a’ nor ‘n’ then the response of the remote ID is compared to the correct response read from the grading key file. If the ID's response matches the correct response then the then a number of points representing the points awarded if correct is added to the remote ID's total 2.39. If the ID's response does not match the correct response then the then a number of points representing points awarded if incorrect is added to the remote ID's total 2.43. This process is repeated for each record of the CSV file and each record of the grading key file while maintaining the total number of points awarded for each ID in memory. When finished, the program outputs the total number of points attributed to each remote ID as well as the total number of points possible to be achieved.

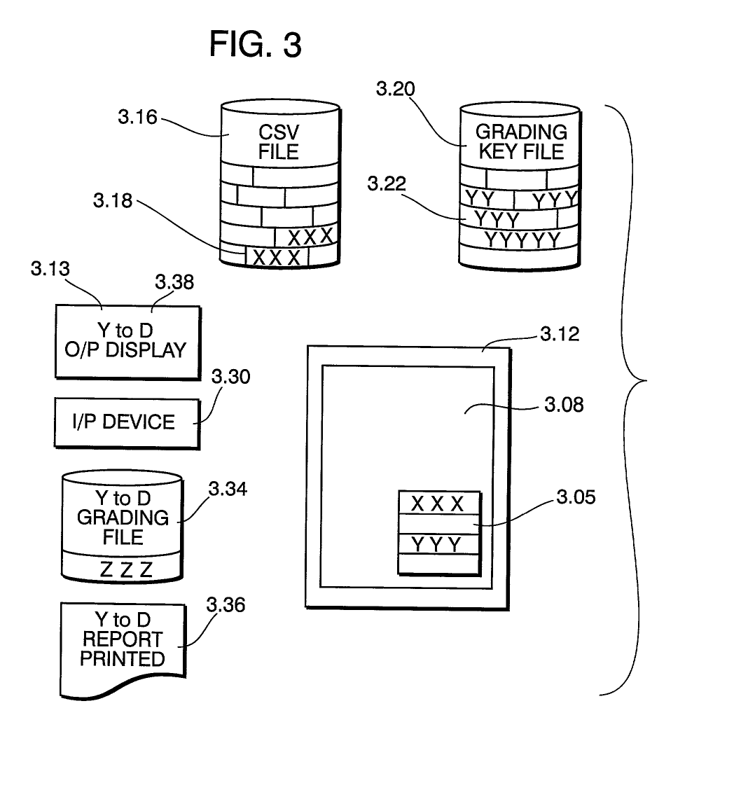

FIG. 3 illustrates the major hardware and software components of the instant invention when practiced in its preferred batch, variable or fixed interval execution environment. As can be seen in FIG. 3, the software of the instant invention 3.05 executes under the dispatching control of a general purpose computer operating system 3.08. When practiced in the invention's preferred embodiment the general purpose computer operating system 3.08 would typically be a Windows or Macintosh operating system or equivalent operating system, though no such limitation with respect to said operating system are implied with respect to the execution of the instant invention computer based methodology 3.05. In an easily envisioned alternative embodiment, the execution of the instant invention could be facilitated via any mid-range computer operating system or mainframe processing operating system, such as but not limited to UNIX, MVS, VM, and others known and practiced in the art. Retrieval of the instant invention software 3.05 for loading into a general purpose computer read access memory may be facilitated by retrieving the software of the instant invention from any computer readable storage medium, such as but not limited to compact disk, floppy disk, zip drive or hard drive or such computer readable storage medium well known and practiced by those skilled in the art. Having once been loaded into a general purpose computer 3.12 read access memory, the software of the instant invention 3.05 retrieves, interrogates and parses information from both a CSV file 3.16 and a grading key file 3.20. The grading key file 3.20 consists of a plurality of individual records 3.22. The CSV file 3.16 also comprises a plurality of records 3.18. Said records 3.18 and 3.22 of said CSV file 3.16 and said grading key file 3.20 can be of variable or fixed length blocked or unblocked record formats. The instant invention retrieval of said individual records 3.18 and 3.22 allow for interrogation of each record field until identifying information can be identified, whereupon processing of the instant invention proceeds as discussed in association with FIG. 2. Upon completion of invention execution, a number of output presentations are made available. Such output presentations include, but are not limited to, a year-to-date grading file 3.34 wherein a student's cumulative in-class participation has been graded and stored for subsequent retrieval and processing, a printout 3.36 showing in hard copy format the year-to-date grading summary or a year-to-date output display 3.38 typically though not necessarily presented upon a screen display 3.13 integrated and communicably attached to said general purpose computer 3.12.

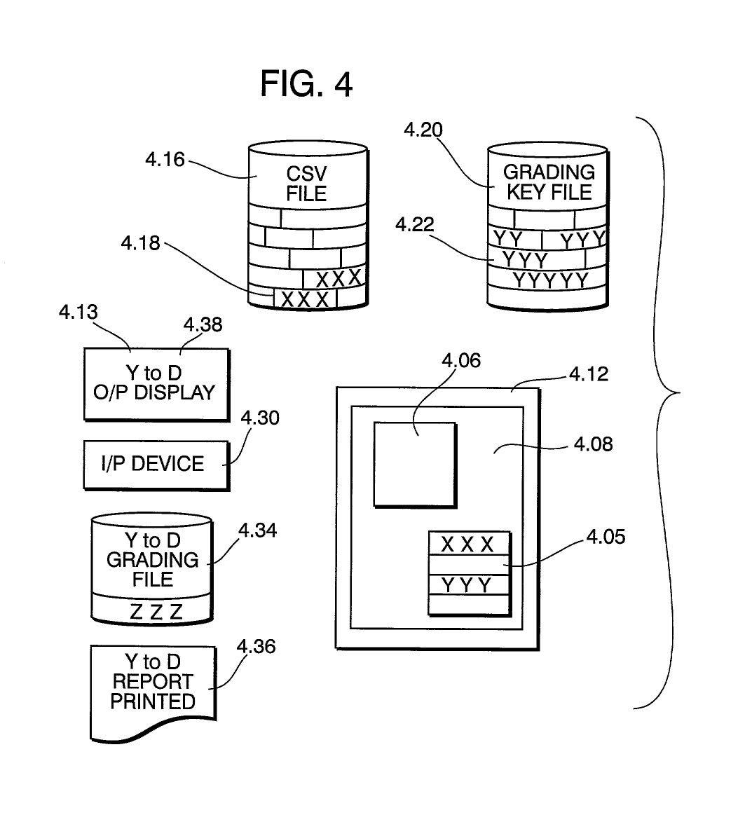

FIG. 4 illustrates the hardware and software components of the instant invention when practiced in its preferred embodiment in a real-time execution environment. As can be seen in FIG. 4, both the software of the instant invention 4.05 and PRS software 4.06 execute within the read access memory of a general purpose computer. The real-time execution of the instant invention is practiced in those situations wherein the instructor wishes to derive benefit of a year-to-date output presentation of student classroom participation grades. Indeed, the real-time execution mode of the present invention allows an instructor to execute the software of the instant invention 4.05 immediately following a student's response. Such real-time execution illustrates further the robust and flexible nature of the instant invention wherein a year to immediate response grading can be provided for any student then identifiable to the instant invention. Presentation capabilities are identical to those discussed in association with FIG. 3 including but not limited to a year-to-date or response printed report 4.06, a year-to-date grading file 4.34, a year-to-date output display file 4.38. As discussed in association with FIG. 2, the real-time execution of the invention 4.05 in its preferred embodiment requires the development and inputting of an identification of a grading key file 4.20 with independently accessible records 4.22 and the identification of a CSV file 4.36 with individually accessible records 4.18. Said development and inputting of grading key file information facilitated by a general purpose input computer device such as but not limited to a keyboard or mouse/GUI interface 4.30.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

What is claimed is:

1. A computer based method for identifying and grading individual response performance when such performance is interspersed within a personal response system generated file structure containing a plurality of performance indicators comprising:
simultaneously presenting via a personal response system a response stimulus to a plurality of individuals;
eliciting a recordable response to said stimulus from said individuals;
digitally recording a recordable response for each individual comprising said plurality of individuals;
attributing said recorded response to each individual comprising said plurality of individuals, and
grading each individual's attributed response performance.

2. The method of claim 1 wherein said presenting, eliciting, recording, attributing and grading occurs in an iterative manner.

3. The method of claim 1 wherein said response recording is facilitated via a personal response system.

4. The method of claim 1 wherein said attributing of a recordable response to each individual comprising said plurality of individuals further comprises:
determining a personal response system digital record of all responses elicited from said plurality of individuals;
determining a grading key to be associated with said determined personal response system digital record;
extracting from said determined grading key a correct response answer variable;
extracting from said determined grading key a personal response system filename;
extracting from said file referenced via said filename a remote transmitter identification code and response for each remote transmitter responding to said stimulus; and
comparing said grading key and said file referenced via said filename to determine a total point value for a remote transmitter responding to said stimulus.

5. The method of claim 4 wherein said determining a total point value for each remote transmitter responding to said presented stimulus further comprises:
adding zero points to said remote transmitter's total point value if a transmitted response is the equivalent of “n”;
adding a correct response point value to said remote transmitter's total point value if a transmitted response is the equivalent of “a”;
adding a correct response point value to said remote transmitter's total if a transmitted response is neither the equivalent of “a” or “n” and said response is equal to a correct answer specified within said grading key; and
adding an incorrect response point value to said remote transmitter's total if a transmitted response is neither the equivalent of “a”, “n” or a correct answer specified within said grading key.

6. The method of claim 1 further comprising outputting the total points attributed to each remote transmitter responding to said elicitation.

7. The method of claim 6 wherein said outputting is a printed report or output video display of year-to-date grades for an individual.

8. The method of claim 6 wherein said outputting is a printed report or output video display of year-to-date grades for a plurality of individuals.

9. The method of claim 6 wherein said outputting is a printed report or output video display of variable time period grades for an individual.

10. The method of claim 6 wherein said outputting is a printed report or output video display of variable time period grades for a plurality of individuals.

11. The method of claim 4 wherein said determined grading key is a response sequence provided via a uniquely identified remote transmitter.

12. The method of claim 4 further comprising digitally storing the identification of said determined grading key as a data structure accessible to a general purpose computer.

13. An apparatus for identifying and grading individual response performance included within a personal response system generated file structure containing a plurality of performance indicators comprising:
a general purpose computer;
a memory that stores a response attribution and grading program;
a central processing unit that, when executing said program, adapts said general purpose computer to analyze data contained within a personal response system generated file structure containing a plurality of performance indicators.

14. The apparatus of claim 13 wherein said executing program's adaptation of said general purpose computer further comprises:
the determination of a personal response system digital record for responses elicited from a plurality of individuals;
the determination of a grading key to be associated with said determined personal response system digital records;
the extraction from said determined grading key a correct response answer variable;
the extraction from said determined grading key a personal response system filename;
the extraction from said file structure referenced via said filename a remote transmitter identification code and response for each remote transmitter responding to said stimulus; and
the comparison of said grading key to said file referenced via said filename to determine a total point value for a remote transmitter responding to said stimulus.

15. The apparatus of claim 13 wherein said determination of a total point value for each remote transmitter responding to said presented stimulus further comprises:
adding zero points to said remote transmitter's total if a transmitted response is the equivalent of “n”;
adding a correct response point value to said remote transmitter's total if a transmitted response is the equivalent of “a”;
adding a correct response point value to said remote transmitter's total if a transmitted response is neither the equivalent of “a” or “n” and said response is equal to a correct answer specified within said grading key; and
adding a correct response point value to said remote transmitter's total if a transmitted response is neither the equivalent of “a” or “n” and said response is not equal to a correct answer specified within said grading key.

16. The apparatus of claim 13 further comprising outputting the total of points attributed to one or more remote transmitters responding to said elicitation.

17. The apparatus of claim 13 further comprising a video display and input device, said video display and input device configured to facilitate user interaction with said central processing unit.

18. A computer readable medium encoded with a computer program for identifying and grading individual response performance when included within a personal response system generated file structure containing a plurality of performance indicators comprising:
an instruction set for determining a personal response system digital record of all responses elicited from a plurality of individuals;
an instruction set for determining a grading key to be associated with said determined personal response system digital record;
an instruction set for extracting from said determined grading key a correct response answer variable;
an instruction set for extracting from said determined grading key a personal response system filename;
an instruction set for extracting from a file referenced via said filename a remote transmitter identification code and response for each remote transmitter responding to said stimulus; and
an instruction set for comparing said grading key and said file referenced via said filename to determine a total point value for each remote transmitter responding to said stimulus.

19. The computer program of claim 18 wherein said determining a total point value for each remote transmitter responding to said presented stimulus further comprises:
adding zero points to said remote transmitter's total point value if a transmitted response is the equivalent of “n” ;
adding a correct response point value to said remote transmitter's total point value if a transmitted response is the equivalent of “a”;
adding a correct response point value to said remote transmitter's total point value if a transmitted response is neither the equivalent of “a” or “n” and said response is equal to a correct answer specified within said grading key; and
adding a correct response point value to said remote transmitter's total if a transmitted response is neither the equivalent of “a” or “n” and said response is not equal to a correct answer specified within said grading key.

20. The computer program of claim 18 further comprising an instruction set for outputting the total points achieved by one or more remote transmitters responding to said elicitation.

21. The computer program of claim 18 wherein said grading key is a response sequence facilitated via a uniquely identified remote transmitter.
